(19) United States
(12) Patent Application Publication
(10) Pub. No.: US 2023/0177211 A1
(43) Pub. Date: Jun. 8, 2023

(54) ANONYMOUS DIGITAL IDENTITY DERIVED FROM INDIVIDUAL GENOME INFORMATION

(71) Applicant: NAVNETICS, INC., Seattle, WA (US)

(72) Inventor: Estelle GIRAUD, Seattle, WA (US)

(21) Appl. No.: 17/920,319

(22) PCT Filed: Apr. 28, 2021
(86) PCT No.: PCT/US2021/029724

§ 371 Date: Oct. 20, 2022

Related U.S. Application Data
(60) Provisional application No. 63/017,561, filed on Apr. 29, 2020.

(51) Int. Cl. G06F 21/62; H04L 9/32; G06F 21/60; H04L 9/08

(52) U.S. Cl. CPC G06F 21/6254; H04L 9/3218; G06F 21/602; H04L 9/3228; H04L 9/0866

(57) ABSTRACT

Computational biomodelling and bioinformatics implemented cryptography/information security are used to generate a variable public identity for a user on a digital public ledger system. Disclosed herein are cryptographic protocol enhancements that prevent a user from being tracked by their public key while still being able to use the functionality of a public key. Each time a user interacts with a public ledger, that user is identified by a random selection of their single nucleotide polymorphisms (“SNPs”) from their genome. The interacting user has a record of the random SNPs used for the interaction and can verify themselves as the interacting user via zero-knowledge proofs validated by their personal genome. However, others will not be able to associate the user's activity with the variable genomic identities. A genomic data structure for encoding multiple streams of genomic and multiomic information further enables the generation of variable genomic identities and web human verification.

### CROSS-REFERENCE TO RELATED APPLICATIONS

This application is a National Phase entry to PCT Application No. PCT/US21/29724 filed Apr. 28, 2021, which claims priority to U.S. Provisional Application No. 63/017,561, titled “ANONYMOUS DIGITAL IDENTITY DERIVED FROM INDIVIDUAL GENOME INFORMATION” and filed on Apr. 29, 2020, which is incorporated by reference herein in its entirety.

### TECHNICAL FIELD

This disclosure relates to computational biomodelling and bioinformatics implemented cryptography/information security. More particularly, the disclosure relates to variable public identification in digital interaction.

### BACKGROUND

When users of publicly recorded systems, such as those that operate using blockchain data structures, interact often users are identified by a public key from a cryptographic key pair. Cryptographic key pairs do not change. As a given user interacts, a pattern of interaction can be built from activity associated with their public key. From that pattern, the user's real identity might be derived (e.g., a pattern of when the user transacts or who the user transacts with provides insight as to whom is behind an anonymous identity). The anonymity of a cryptographic identifier is not necessarily enough to protect one's identity when the user frequently uses the same cryptographic identity.

The world of “Big Data” is full of many entities that do not particularly trust one another and compete directly but still benefit from mutual sharing of data. One such example of mutual benefit through data sharing is in the training of machine learning or AI modules. Machine learning applications improve with additional training data; thus, sharing of training data between parties improves the overall function of these modules. Despite the clear mutual benefit, where the parties do not have reason to trust one another, precautions must be taken.

### BRIEF DESCRIPTION OF THE DRAWINGS

FIG. 1 is a flow chart illustrating a method of generating a variable cryptographic identity (“genomic key”).

FIG. 2 is a flow chart illustrating a method of verifying a user is party to a transaction on the blockchain.

FIG. 3 is a flow chart illustrating verification of a human on a social media platform.

FIG. 4 is an illustrative block diagram of a single-entity system architecture.

FIG. 5 is an illustrative block diagram of a multi-entity system architecture with a single data store.

FIG. 6 is a block diagram illustrating an example of a computing system in which at least some operations described herein can be implemented.

### DETAILED DESCRIPTION

In this description, references to “an embodiment,” “one embodiment” or the like mean that the particular feature, function, structure or characteristic being described is included in at least one embodiment introduced here. Occurrences of such phrases in this specification do not necessarily all refer to the same embodiment. On the other hand, the embodiments referred to also are not necessarily mutually exclusive.

Disclosed herein is a technique to make use of a user's genomic information to provide a variable, cryptographic, public identity. In some embodiments, each time a user interacts with a public or permissioned ledger, that user is identified by a new, random selection of their single nucleotide polymorphisms (“SNPs”) common in the human genome. The user whom interacted has a record of the random SNPs used for a given interaction and can verify themselves as the interacting user via zero-knowledge proofs validated by their personal genome. There are roughly 50,000 common SNPs in humans (Minor Allele Frequency as of filing (MAF)>0.25-MAF<0.75). Based on the random selection of SNPs, it is unlikely that any given user would ever be identified in transaction records because that user would not use the same public cryptographic identity twice.

A problem solved herein is to prevent patterns of behavior from being associated with a given static cryptographic identifier. A user may interact with a blockchain system in a manner that enables them to provably establish they were the user interacting in a given record, while simultaneously preventing outsiders/non-trusted parties from building a pattern of interaction through use of a static cryptographic identifier.

In some embodiments, it may be necessary to add an additional layer of identity protection to the individual SNP information used to generate the cryptographic public identity. This is largely due to the fact that SNPs in themselves can be identifying information. One way of masking this potentially identifying code is to include some information loss in the public identifier that preserves the capability of the individual to cross reference the SNP sequence with their genome to identify themselves in the ledger.

Other problems solved herein include more efficiently encoding multiple streams of genomic and multiomic information, and verification of humanness on social media-type applications (or other user account managed platforms).

For example, if a user has a database including private data (e.g., their genetic or genomic information and/or other medical data about that individual) and the user wishes to submit that data to a bioinformatics study without sharing any personally identifying information (PII), they are able to do so without creating records that can be tied to them through a static identity (even if that static identity is anonymous). An example of such an instance is where a given user supplies or allows access to their personal genome (in an encrypted fashion) to a group building bioinformatics AI models.

In some embodiments, the user is identified by (e.g., in addition to or in replacement of SNPs) time varied portions of their genome, such as via DNA methylation or RNA expression. Identical twins will often have the same SNPs, and thus use characters deriving from DNA methylation will differentiate these users. Further, if a user's genome is ever captured/stolen, use of methylation status at various points in that user's life provides additional layers of security. Other examples of otherwise time-varied genomic information include, histone acetylation, time point based transcriptome information, or V(D)J adaptive immune system status. Each contributes to unique elements of a given person's genomic information that may be implemented as a seed element for a cryptographic key that will vary over time.

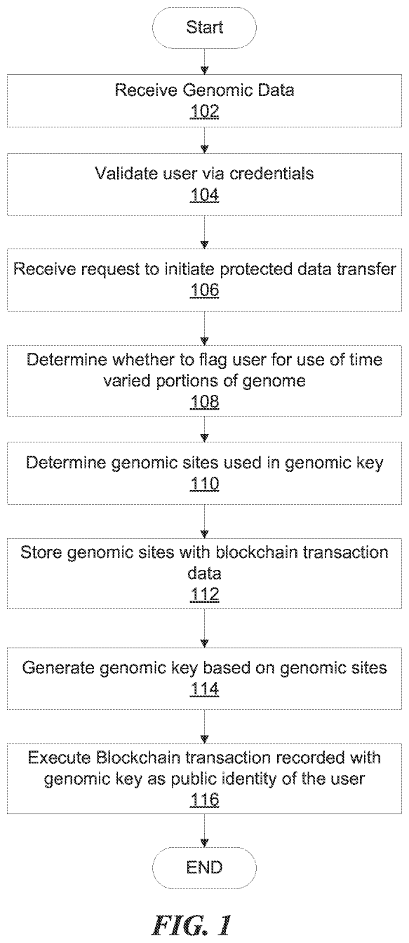

FIG. 1 is a flow chart illustrating a method of generating a variable cryptographic identity (“genomic key”). The public identity created may vary from embodiment to embodiment. Examples of the public identity include: the public key in a set of cryptographically related keys (a public and private key pair) or a pseudonym to replace the public key in records. Either example type may be either static or limited-use (e.g., one-time, two-time, etc.).

In some embodiments, generation of the public identity is linked to the creation of a new cryptographic key pair. An unpredictable (typically large and random) string is used to begin generation of a pair of keys suitable for use by an asymmetric key algorithm. A genome is a large pseudo-random string. That is, the human genome uses 4 characters across approximately 3 billion positions/sites. While many of those sites are merely consistent with being human (and are therefore not varied), a statistically relevant length of the genome is variable and/or pseudo-random.

SNPs are an aspect of the human genome that appear pseudo-random. By using common SNPs from which to derive a genomic key, combined with some form of information masking, for example deriving only 2 values from the 3 possible SNP allele options (AA/AB/BB), relatability is also masked (e.g., genetic family relationships cannot be deduced by comparison of SNP sequences).

In some embodiments, a user's cryptographic key pair (e.g., keys used to interact with a blockchain on a cryptographic level) is unrelated to the user's genomic information, and the user's genomic information is utilized to generate a limited-use pseudonym (e.g., one-time) to take the place of the user's public key in a given transaction record. For purposes of this disclosure, the key that derives from the user's genomic data is referred to as the genomic key regardless of other implemented features of said key (e.g., whether the genomic key is part of a cryptographic key pair, or whether the key is static or limited use).

In step 102, a data management system receives a given user's genomic data. In different embodiments, the form of the genomic data may vary. Examples include flat files that plainly recite genomic data (e.g., FASTA or FASTQ files), alignment data files (e.g., BAM or SAM files), call formats (e.g., VCF or BCF files), other suitable genomic file format known in the art, or file formats disclosed herein.

The genomic data for the user is stored in a database (e.g., on personal devices, in cloud/edge storage, or in local servers). The genomic data is used in later steps to develop a genomic key or verify whether a given instance of a genomic key belongs to the active user. Access to the source genomic data may be based on direct manipulation of the relevant digital files, or via an authorized device.

In step 104, the data management system validates the user via credentials. The credentials may be cryptographic means known in the art (e.g., password and/or key pair based). In some embodiments, the user's genome, or parts or representations thereof may be used as keys. In step 106, the user initiates a protected data request or transfer. The other party in the data request or transfer has a known public identify (e.g., a static public key). In some embodiments a transaction may occur between two parties protected in the transaction record by a genomic key; however, the initial transaction request makes use of at least one known public identity. That is, the initialization of the transaction makes use of static public keys, but the record stored on the blockchain makes use of variable genomic keys.

In step 108, the user indicates to the data management system whether they are a twin or have reason to use evolving genomic data from which to base their genomic key. Twins have largely the same genetics. Thus, a key based solely on the user's genes would be able to be confused with the other twin a statistically significant amount of the time.

However, portions of a mammal's DNA changes over time. Epigenetic modifications are persistent and heritable changes made to the DNA, which regulate how genes are expressed, but do not affect the nucleotide sequence itself. One example of Epigenetic modifications include methylation status. Indications of the presence of methylation at various sites within the user's genome change over time. Additionally, there are DNA sites that are methylated in a unique per individual pattern. An example of such methylated sites are correlated regions of systemic interindividual variation (CORSIVs). Today, there are roughly 10,000 known sites genome wide that correspond to unique methylation signatures per individual, set at birth/in utero and stable of life and all tissues. This number of sites may increase in future. In some embodiments, CORSIVs sites may be incorporated into the set of sites used for variable cryptographic identity for identical siblings. A CORSIV may be incorporated into the genomic key via a binary value. Specifically, the binary value stores whether the indicated site is methylated. In some embodiments, the CORSIV is incorporated as a more complex value based on the extent of methylation.

Other epigenetic modifications or otherwise time-varied genomic information includes, histone acetylation, or time point based transcriptome information.

Another time-varied genomic element is a person's immunogenomic history. Specifically, the antigen receptors expressed by T cells (T cell receptors, or TCRs) and B cells (B cell receptors, or BCRs, and soluble antibodies) represent a record of an individual's history of exposure to antigens, whether from pathogens, allergens, or other sources. The mechanism that generates variation in the antigen-binding pockets of these receptors involves mixing and matching variable (V), diversity (D), and joining (J) gene segments in a process called V(D)J recombination. To assemble a single functional receptor, preexisting V, D, and J gene segments are rearranged to yield a contiguous V(D)J region. These V(D)J rearrangements thus define T cell or B cell clonotypes with specificity for specific antigens, and such clonotypes may be maintained over time by clonal expansion and clonal descent from the primary T or B cell originally exposed to a select antigen. Thus, the adaptive immune system's V(D)J clonality, diversity, and specificity is a viable time-varied set of genomic information.

In addition to twins, if a malicious actor/thief obtained a copy of a user's genome, use of CORSIVs sites as part of the genomic key enables the source data for the genomic key to change over time, and the malicious actor would be unlikely able to identify the user's recorded blockchain transactions from uses of the various iterations of the genomic key. Additionally, only the true user would have a record of the specific random SNPs used in the transaction history, a malicious actor having access to the person's genome, does not give insight into the historical random SNP selection of the genomic key public identifier, frequency or time of interactions etc on the ledger.

The indication in step 108 may be an account setting, a pre-genomic key generation setting, or may occur automatically based on the extent of detail contained original source genomic data referenced in step 102.

In step 110, the data management system determines the genomic sites used for generation of the genomic key. Sites are randomly selected from those in an available pool (and having a random order). The available pool may draw from any portion of the user's genome. However, in some embodiments, the available pool is limited to a specific set of SNPs, and/or CORSIVs. In some embodiments, a user's genomic key makes use of a limited number (e.g. 96, 96 or more, etc.) of the user's available pool of sites (e.g., SNPs and/or CORSIVs). While less than 96 sites may be used, the chances that two users have the same values at 95 sites is statistically relevant. The use of more sites improves the odds that no two users would ever have the same values at the same set of sites.

Referenced above, there are roughly 50,000 common SNPs in humans having a MAF within the range 0.25<x<0.75. MAF, in this context, refers to the frequency of the second most common allele at a given site with respect to a reference genome. Because the reference genome does not change as frequently as the data, in many cases, the “second most common allele” at a given time, is actually the most frequent known allele at that site.

The way MAF is interpreted will change over time as references genome become updated and improve. The quality of collected genomic data directly correlates to the definition of MAF approaching a strict MAF—that is, the reference genome becomes highly accurate and the second most common allele at a site must occur at x<50% (e.g., cannot be 0.75 as described in the above range). As a MAF approaches a strict MAF, the SNPs used by the data management system herein may vary.

Some guidelines in selecting the SNPs used by the data management system include: those SNPs that vary in around 50% of the population, those SNPs with a strict MAF greater than 25%, the X most variable SNPs (e.g., X=50,000), and/or SNPs with an Alternate Allele Frequency (AAF) of 0.25<x<0.8 (wherein the AAF is a combination of the frequency of all potential minor alleles and the possibility of an indel). While not completely random, the variability is suitable from which to derive public/private key pair. In some embodiments, the public/private key derived from available SNPs is a one-time key pair.

SNPs and CORSIVs are used as an example of potential sites that may be used. Further genomic analysis on humans is anticipated, and any site within the human genome (regardless of whether it is a SNP) having any MAF range described above is a strong candidate. Additionally, RNA expression signatures at specific time points, or copy number variations (CNV) are additional examples of unique biological human to human variation that could be considered or integrated in the genomic key.

In step 112, once the sites are selected randomly from the implemented embodiment of the available pool, the used sites are stored along with a timestamp of the transaction making use of the genomic key. In the future, when the user wishes to verify that a given transaction of the blockchain was them, knowledge of which sites were used is necessary information for at least one party during said verification.

Various embodiments store the sites used/timestamp differently. In some embodiments the sites used/timestamp may be a trusted 3rd party. The sites used/timestamp may be publicly or privately on the blockchain (e.g., via a smart contract that executes a zero-knowledge proof challenges on users seeking verification). Additionally, the sites used/timestamp may be stored on a user device/database as private records.

Where the sites used/timestamp are stored on the blockchain with the transaction, zero-knowledge proofs executed to verify a user as a participant to the transaction can be publicly or privately depending on which party/parties are intended to demonstrate knowledge of secret information. In one example, the sites used is stored privately with the transaction and when queried, the data management system may challenge the user's genomic data (from step 102) with a zero-knowledge proof based on the public genomic key used in the transaction, and the secret sites used for that transaction. Such challenges may be automated and performed en masse as part of a blockchain search feature (e.g., “find my transactions” type search).

In step 114, the data management system generates the genomic key based on the sites selected. In some embodiments, the genomic key is a string representing the alleles present at each of the randomly selected sites for the genomic key. In some embodiments, the genomic key is a binary representation of the randomly selected sites. Rather than indicate the user's specific allele at each site, a 0 is used to indicate presence of the major allele, and a 1 is used to indicate the presence of any minor allele (or vice versa). Further, as noted above, CORSIVs may be represented as a binary value indicating whether a given site is methylated.

In some embodiments, binary values may represent 3 possible outcomes at a SNP site. The three outcomes including, allele AA (REF)=value 1, allele AB (REF/ALT)=value 0, allele BB (ALT/ALT)=value 0. Thus, from the binary public identifier derived from common SNPs, it would not be possible to determine the specific genotype. Notably, there are other encoding techniques (e.g., other than binary) that mask biological information used in the public, genomic key, while still preserving uniqueness and ability of the individual to track their identifiers in the ledger.

The output of step 114 is a set of numbers or characters that is used as the genomic key.

Steps 110-114 (and sometimes 108 depending on embodiment) are performed each time a new genomic key is requested.

In step 116, the relevant blockchain transaction is executed and the genomic key is recorded to the public ledger as identifying the user's participation in the transaction.

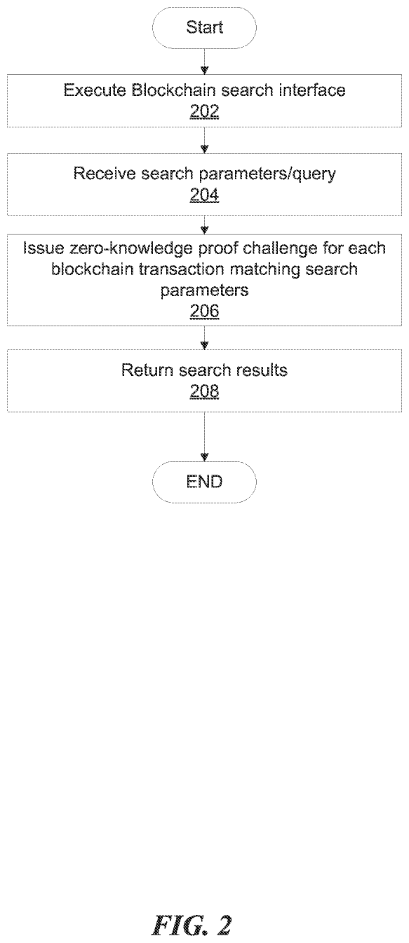

FIG. 2 is a flow chart illustrating a method of verifying a user is party to a transaction on the blockchain. In step 202, a user opens a blockchain search interface. In step 204, the user indicates parameters for searching the blockchain. Parameters include any combination of filterable subject matter such as: date ranges, type of data transacted, public participants in the transaction (e.g., users whom do not use a variable cryptographic digital identity), and whether the searching user participated.

In step 206, where the user has indicated that the search query at least includes a set of transactions that they were a participant in, the data management system delivers zero-knowledge proof challenges on each transaction within the search parameters. The zero-knowledge proof is used to identify whether the searching user was a participant. The data management system, via data stored associated with each transaction (e.g., via smart contract or encrypted transaction data), has access to the randomly selected sites that were used to generate the genomic key associated with the transaction. Conversely, the user's device has access to the user's full genome. All parties are aware of the values of the genomic key used for a given transaction (e.g., the 96 bits associated with the transaction).

Another potential use case is the controlled and user consented re-contact that may be necessary as part of a scientific research study. For example, if data is shared with a researcher in an anonymized or encrypted way and there is a significant finding from the study where the researcher would want to contact the participant or groups of participants; the ledger can be used via a query to identify participants via zero knowledge proofs and prompt individual users for their consent to re-contact before disclosing any identities or contact information to the researcher.

Based on the informational split described above and through use of efficient genomic data structures, a zero-knowledge proof can be executed for every transaction on the blockchain (including a billion transactions) in less than a second on modern hardware.

In step 208, the blockchain search engine returns results of the user's search based on the parameters and successfully answered zero-knowledge challenges.

### Genomic Data Structure

The above data management system references an encoding format for a genome. The standard file formats for consuming genomes are FASTA and FASTQ, both are intended to be human readable. These formats are flat files that use ASCII characters that each individually represent a single point of data (e.g., one nucleotide or protein per character, or one read quality indicator per character). Because these formats strive for human readability, the encoding is extremely inefficient.

Many bioinformatics models (machine learning/AI) and bioinformatics tools (e.g., NCBI BLAST) operate using the human readable FASTA and FASTQ files. Accordingly, the algorithmic efficiency of these models and tools suffers. There are more specialized file types, such as BAM files which are written in binary. Encoding in binary is more efficient than in ASCII, but the file format does not always follow a typical encoding scheme and tends to encode where a single binary code word merely encodes a single data point (e.g., one nucleotide or protein per character, or one read quality indicator per character). The BAM format does not take advantage of any structural efficiency that computer-only readable files can use.

Conversely, where a flat file encodes relevant data to 8, 16, or 24 bit “pixels” (e.g., either a visible image file pixel, or alternatively a data structure that stores information similarly to a pixel), the compression of the relevant data is significantly more efficient. Each position in the flat file corresponds to a position in the genome. Each “color” (e.g., 256 options in 8-bit to nearly 17 million in 24-bit) encodes not only the base at the given position, but a number of other potential features.

Examples of potential features that are encodable to each base pixel include any combination of: the quality of the read for the base; whether the base was imputed; whether the base is methylated, and the extent of methylation; whether there has been CNV; whether the base has particular relevance in DNA transcription, translation, or protein encoding; whether the base is associated with a particular gene; the technology platform used to determine the biology (e.g., next-gen sequencing, microarray technology and the specific technology vendor); the original source of the base (e.g., specific clinical testing laboratory or company that performed the analysis, Gen Bank, et al.); quantitative information on the structural scaffold of the genome (e.g., 3D signals for CNV, expression levels); changes to the base (e.g., methylation status, expression, or mutation) over a period of time or separate sequencing events; or other allele statuses known in the art.

Where changes in a given dimension are captured over time, the dimension of time, the genome file may be executed as a 2D or 3D “movie” over time that represents an individual's biological changes over time. The encoding space further allows for ability to localize or anchor the genome file to a region of the digital representation of the organism body, including physically mapping multiple “genomes” on a 3D space over time, applications include creating a digital representation of tumor biology and metastases over time, immune/infection response over time (e.g., V(D)J adaptive immune system). Use aspects of this movie and/or image in a password type functionality for a person's unique biology over a specific time period (e.g., see above in varying a user's genomic key in instances of a twin genome or a stolen genome).

Using 24-bit bases across the ˜3 billion bases (or ˜6 billion diploid bases) in the human genome, an uncompressed file size is approximately 16 GB. Current file sizes for the entire human genome in BAM format tend to be ˜90 GB, this can be even larger for other upstream file outputs for a human genome. Using a pixel-like data structure further enables the genome file format to take advantage of image compression techniques.

The disclosed format (“genome file”) is enabled to integrate multiple genetic testing information streams, from various analyses, into one single file and is based on an individual's complete genome (not compared to a reference genome as is current standard).

The genome file is a flat file, 2D or 3D “image” file where each “pixel” or positional entry is encoded to represent a base, in known and fixed order/position in the genome along with any additional information known about that base. This position of each base in the file format is the exact same across files for different individuals. The positional reference is a full, diploid, phased human genome.

Image “shape” is not restricted. Rectangular 2D/3D image constraints are arbitrary in this case and file could leverage a 1D flat file of genetic sequence, or some other non-rectangular form. The file may be a 1×3 billion rectangle or any combination of dimensions that fits all the genome.

Encoding scheme for each base can leverage existing 8 bit-256 color schemes, (or additional channels may be added as needed). The probability or quality scores of the data point representing the correct base can be captured in 8 bit-256 color space for example and the accuracy resolved later as additional data and/or replication is added to the file. Research grade data/imputed data/genotyping arrays/NGS/clinical grade validated next-generation sequencing (NGS) data are all encoded in a single file, differentiated by different values in specific channels (akin to tonal variation in color files).

The genome file may be derived from any number of originating formats and the originally sequenced genome may vary in quality. The quality of the various sequenced genomes recorded in public databases vary in quality, and over time as the technology has improved. Public databases have little quality control on submissions. As legacy file formats are converted to the genome file format, in some embodiments, a set of values are encoded into each “pixel” as a confidence in the source of the original data. The confidence in the source is a separate, additional statistic to read quality scores.

The genome file may also be converted back into legacy formats including VCF files and other standard file formats via comparison to a reference genome file and exported to other applications if desired.

Genome files are each indexed to identical human genome positional context thus providing computational ease of extraction for specific genetic regions across many individuals. The indexing also allows ease of comparison at a particular site across a whole population of individuals.

The genome file format further enables standardized image filtering and masking techniques to select specific regions for any data sharing. In addition to retaining an anonymous identity while transacting with data (described above), data shared may be limited. For example, in some embodiments, the data management system enables users to specify sharing of specific regions or groups of a genome file (e.g., specific genes, or protein sequences). Additionally, the genome file format enables the user to filter out bases from data shares. For example, bases a user may filter out may be those that are within intron or exon regions, or those that are SNPs or CORSIVs used in the generation of the genomic key.

This file format also allows for potential advantages to the ease of use of image recognition/pattern recognition/AI technology on genome “image” files, and has advantages for the use of AI on genomics data for the following reasons:

A) the genome file is a standardized individual to individual file structure and indexed DNA base information.

B) the ability to leverage imputation and data from various levels of confidence to gain a more complete picture of an individual genome in absence of population scale whole genome sequencing in the foreseeable future (e.g., machine learning or AI models are be trained earlier using imputed data and resolved in resolution over time with more concrete data).

C) the ability to include many aspects of biology into a single file for model training, instead of having multiple files per individual (separate file for Genome DNA sequence, CNV data, expression data, methylation patterns etc).

In some embodiments, compression of the genome file is achieved via tiled pixels of known sequence combinations (hashed tiled sequences), or via existing image compression techniques and algorithms.

### Social Media Genomic Verification

Social media is awash with bots or multi-account users. Bots and users whom control a large number of accounts are able to drive social media platforms in toxic ways that are detrimental to legitimate users of the platform.

Similarly to generation of a genomic key as described above, a social media genomic verification illustrates that a given social media account is operated by a human, or links multi-accounts such that the platform is aware that all of the accounts that are tied to the same human.

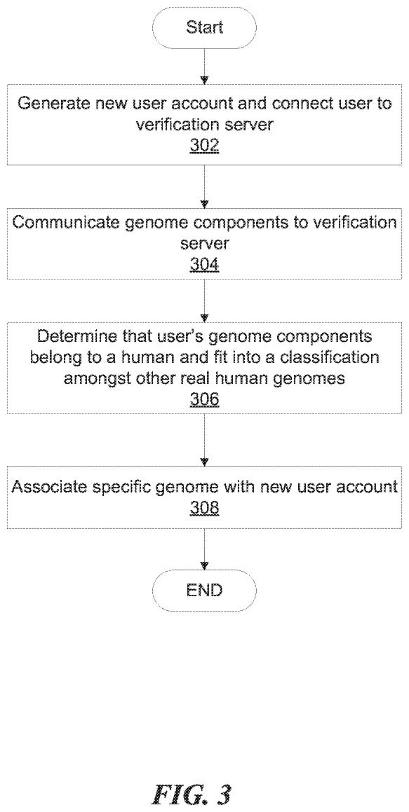

FIG. 3 is a flow chart illustrating verification of a human on a social media platform. In step 302, a user creates a new social media account (or an existing account is subjected to verification). During creation the user connects to a verification server. In step 304, while connected to the account creation server, communicating the user's genome file or portion thereof to the verification server. Said communication may include transmission of the genome file (or part thereof) or include issued challenges by the verification server that are automatically answered by the user device using the genome file as a reference. The communications may also be mediated via a third-party platform with registered human identities via the genome files.

In step 306, the verification server identifies whether the genome file of the user belongs to a real human. That is, determine whether the genome matches expected norms for a human genome. In some embodiments, matching expected norms of human (e.g., Homo sapien) genomes includes alignment to a database of human genomes and mathematically placing the new genome into a tree with the overall database. A real human will be mathematically related to other humans. That is, some percentage of the new genome should match the genomes of other related humans and that percentage halves each generation. If a given genome does not exhibit the mathematical relationship of halving matching portions across generations, the genome is a fake human. A strong human genome database will link to most newly input human genomes at multiple points. In some embodiments the verification further includes identifying a taxon for which the genome file fits.

Identification of human realness for the genome file prevents the user from synthetically generating a “generic” human genome. A real human's genome will connect to a family line of other genomes within the database. If the verification server determines that the new account does not belong to a real human, the user management platform may determine to either reject the account creation or generate a non-verified account.

Where the user's genome file matches human norms and fits within a human genome database, in step 308, the user is verified as a human and the social media platform is informed that the new user account is associated with a particular human (whom is either new to the social media platform or has previously been associated with another account).

The reference to a social media platform as an account manager is intended to be illustrative. Other digital services that manage a set of user accounts may also implement a similar technique of human verification for their users. While it is feasible for a human verification process to be performed with a legacy file type, the genome file format disclosed herein enables machine-efficient handshaking and ease of partial sharing.

### Blockchain Data Transmission System

Disclosed herein is a system wherein a blockchain system interfaces with a separate database. Data stores referred to herein include examples such as a server database, a filesystem, or a data management system, similar to a Windows, OSX or POSIX (unix) machine. Additional examples include cloud drives, such as Google Drive, Amazon Web Services (AWS) S3, or other cloud data stores. The system further supports Filesystem in Userspace (FUSE) such that one can mount a drive and interact with the filesystem in Windows or OSX and get data provenance and access control permissions as well. To keep track of the events in a given data store, event metadata is embedded into a blockchain ledger.

Embedding data in a blockchain ledger, such as the Bitcoin/Ethereum/Hyperledger blockchain, is used in many cryptocurrency applications. Every cryptographic blockchain transaction contains input(s) and output(s). Ethereum and other coins may also include smart contracts associated with transactions. Cryptocurrencies and non-coin-based ledgers allow an output to contain arbitrary data, simultaneously identifying that it is not a spendable output (not cryptocurrency being transferred for a later redemption). The arbitrary data may be a hashed code that contains a significant amount of data. As long as the submitted transaction is a valid transaction, that transaction (“encoded transaction”) will be propagated through the network and mined into a block. This allows data to be stored with many of the same benefits that secure the blockchain. Everything disclosed herein with reference to distributed ledger applications and technology may also be leveraged on permissioned blockchains in absence of cryptocurrency tokenization, for example on Hyperledger Fabric, with smart contract capabilities.

Once data is stored in the permissioned ledger or blockchain ledger (especially on the Bitcoin/Ethereum/Hyperledger main chain), it is exceedingly difficult to remove or alter that data. In this sense, a blockchain ledger is immutable. In order to make changes to posted blocks to the Bitcoin blockchain, one must control 51% of the mining power of the network. Because the number of Bitcoin nodes is in the thousands, the Bitcoin blockchain is effectively immutable. In some embodiments, and in privately controlled cryptocurrencies, the records stored on the respective ledgers are more susceptible to hijack or take over as a result that nodes are less numerous. However, the risk is low, and properly administered blockchain ledgers, be they public or private, are considered immutable.

The resulting effect is that whoever creates the transaction with the data can prove that they created it, because they hold the private key used to sign the transaction. Disclosed herein, proof of personal connection to the genomic key through zero-knowledge proofs also proves that a given user was party to a transaction. Additionally, the user can prove the approximate time and date the data became part of the blockchain ledger.

The disclosed system presents a data management system for data provenance and data storage that allows multiple independent parties (who may not trust each other) to securely share data, track data provenance, maintain audit logs, keep data synchronized, comply with regulations, handle permissioning, and control who can access the data. Connecting the data management system a blockchain creates a secure and completely auditable system of document tracking that can be shared among untrusted parties over a computer network. The system works both with public blockchain ledgers (for the purposes of this disclosure immutable cryptographic ledgers are referred to as merely “blockchains”), like Bitcoin and Ethereum, Hyperledger, and with private blockchains.

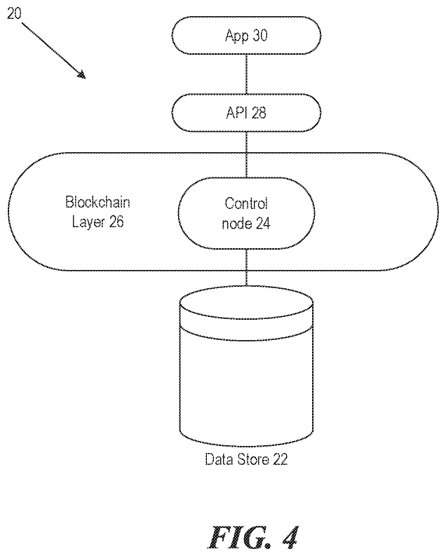

FIG. 4 is an illustrative block diagram of a single-entity system architecture 20. The underlying data store 22 can be an existing data store (i.e., Amazon Web Services S3 or a file server or database) on top of which a control node 24 can run and provide additional functionality. The control node 24 in the blockchain layer 26 and API 28 component is the core of the system architecture 20.

The API 28 and the control node 24 are software components installed as machine-level, software gateways to the data stores 22. Custom user supplied applications integrate with the API 28. Even though these components are installed at each machine, it is unnecessary for there to be a coordinating backend server. However, in some embodiments, there is additionally a backend server to push updates to the control nodes 24 and APIs 28.

The application/entity 30 component can be any software application built on top of this system that needs to store and retrieve the data or retrieve the data provenance and audit trails. Applications 30 that can run on this system include: various analytics apps to visualize data provenance, permissions, data access, regulatory and compliance apps to provide auditing and verification capabilities, and machine learning applications. For the purposes of this disclosure, the terms “application” and “entity” are nearly interchangeable. Each refers to a software application, a party that operates that software application, or a party that acts in the interest of that software application.

The API component 28 is a software interface that interfaces with the app 30 (or user) and supports commands for data storage and retrieval and changes the permissions of access control for the data. The API 28 communicates the commands to the control node 24. The control node 24 connects to the blockchain network (or networks, possibly more than one, and possibly both public, like Bitcoin and Ethereum, or private/permissioned, like an intra-company blockchain) and to the data store 22. The control node 24 enforces the permissions and access to the data in the data store 22 and creates the audit trail for data provenance, permission changes, and all app 30 (or user) actions. The audit trail and permissions are stored in the data store 22, and they are also stored or hashed into the blockchain layer 26 to prove the correctness of the audit trail and permissions. The original file content data (e.g. a genome file) is stored in the data store 22. Metadata, hashes of the data, permissions or hashes thereof, and the commands are written to the blockchain via the control node 24.

The control node 24 interfaces with a blockchain that may support programmable smart contracts. Smart contracts may be used in a preferred embodiment to implement any subset of functionality. Zero, one, or more than one smart contract may be utilized to provide data services via blockchain. In a preferred embodiment, one smart contract is used for data provenance and another smart contract is used for recording data ownership and permissioning. In some embodiments, the genome file is utilized as a key to access to the data.

When data is stored in the data store 22, the hash of the data, owner of the data, and the data permission is written to the blockchain along with hashes of any source data for data provenance (e.g., the genomic key). The actor or actors responsible for this writing may include one or more smart contracts on the blockchain itself or an external network service process.

When the data is to be retrieved, a smart contract or external network service process may be used to check if the retriever has permission to access the data. If so, then access is granted to the data on the data store 22. This access is also recorded in the blockchain. In some embodiments, if access is not allowed, that is also written to the blockchain.

When data is updated, similar to retrieval, first the permissions are checked with the smart contract. If the permission exists, then the hash of the updated data and the source of the data (provenance) is written in the blockchain.

As established above, the blockchain contains an immutable audit log of all the activity. This component is significant in the system because unlike centralized data provenance solutions, the logs and execution of contracts in the blockchain do not require trusting any single party. Multiple untrusted parties are together ensuring that the data on the blockchain is correct. Blockchains such as Ethereum support public and private keys for doing cryptographic signatures. The control node 24 can use the native addresses based on public keys in that blockchain as the mapping to users in the system 20. Authentication of a user is performed via the algorithm that the blockchain uses by cryptographic signatures using the user's key.

The data store 22 can be any existing data store such as AWS S3, Google Cloud Storage, Microsoft Azure Storage, Box.com, an independent file server, or a single laptop. The data store 22 can also be a distributed data store such as IPFS (InterPlanetary File System) or a distributed database. The appropriate interface in the control node 24 interfaces with each type of data store 22. This has the advantage that existing data stores 22 may continue to be used within the system 20. Different types of data stores 22 can be used in the same system, and even though they each have different interfaces, the API 28 provides a common interface to all the data stores 22.

In some embodiments, for efficiency, the file content data is stored off the blockchain in the data store 22. Hashes of the data and permissions and the audit log (reads and writes to data on the data store 22) are stored on the blockchain. This provides privacy of the file content data as well as increased efficiency for scalability.

In some embodiments, at least some of the account keys (public and private) remain as inaccessible data within the control node 24. The account keys may pertain to no particular user or application and are created for the purposes of record keeping. Activity of users is identified by their genomic key. For example, one set of account keys (public and private) of the blockchain layer 26 may be used by the control node 24 on behalf of a group of users of the application 30 to store data access control permissions for the whole group. Transaction data includes the respective genomic key of a user of the group. In another example, a given set of account keys may pertain specifically to a subset of data within the data store 22. In some embodiments, the control node 24 performs all handling of such accounts and the use of cryptographic recordation remains transparent to the user.

Alternatively, in some embodiments, a given control node 24 maintains a single blockchain account and embeds all necessary data access control, provenance, and audit log details in transactions with the single account.

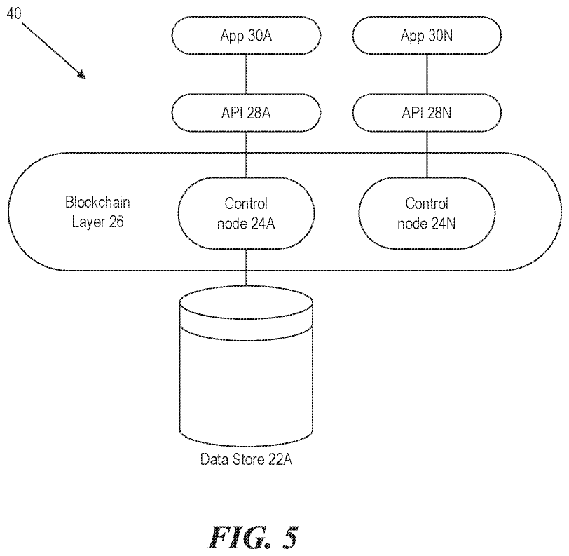

FIG. 5 is an illustrative block diagram of a multi-entity system architecture 40 with a single data store. In this configuration, there is an entity/application 30A that has an associated data store 22A, and one or more other entities 30N that are communicatively coupled to within the multi-entity system 40. There are a number of circumstances where such a configuration occurs. One such example is where a given entity/application 30N performs a compliance role and uses the multi-entity system 40 to monitor the data of the first entity 30A in data store 22A in order to ensure compliance.

In another example, the data store 22A is a cloud storage server and entity 30N is the data owner. In this example, entity 30N is using the data store 22A of entity 30A as a data store for resident applications. In a reverse example, entity 30A is the owner of the data and shares the data to application 30N to execute functions on the data.

In the case where entity 30A is the owner of the data and entity 30N is using the data in an application, entity 30A may monetize the data usage directly via payments using the cryptocurrency of the blockchain layer 24 based on tracked and permissioned data usage. Entity 30A may provide a benefit for entity 30N using entity 30A's data (e.g., training an AI model for entity 30N). In this multi-party data sharing case, the data from data store 22A may contain Personally Identifiable Information (PII) which cannot be shared. The PII data can be stripped out via control node assigned permissions and only non-PII data is shared. A third party can participate by running a compliance node as described in another example earlier and monitor that no PII data is shared.

Artificial Intelligence (AI) has made huge achievements in recent years. Genomics is a field where AI models are used to demonstrate homology between various taxa. Genomic AI models further help researchers understand gene expression in organisms and one key factor for the success is that today AI has the capability to process massive data and utilize those data to decrease error rates to pass the success baseline. However, most of the AI applications today utilize the training data to train the model through a centralized and controlled environment. The multi-entity system architecture 40 enables controlled sharing of this information without divulging PII.

In an example, the multi-entity system 40 is enabled to provide data access control via commands provided via an API 26 to a control node 24 and let the machine learning expert access the necessary data. The machine learning expert is able to take that data, transform it into training data, and feed the data to the machine learning models. Additionally, there may be another type of entity who performs model/data validation to make sure the machine learning expert used the right data to train the model. Those service providers may be paid by utilizing the natural payment functionality in the blockchain layer 26.

The multi-entity system 40 provides clear data provenance for the AI models that were trained. The control nodes 24 generate transactions to the blockchain layer 24 that embed the audit logs for exactly whose data was provided to train the AI models. This process creates a virtual marketplace that allows AI/machine learning service and data sharing to be transacted in a secure and distributed environment among many parties.

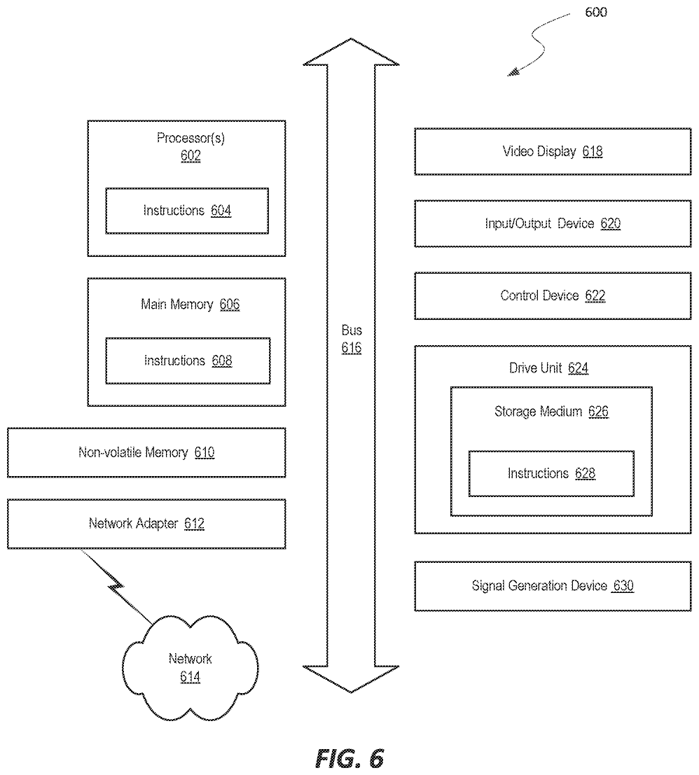

FIG. 6 is a block diagram illustrating an example of a computing system 600 in which at least some operations described herein can be implemented. The computing system may include one or more central processing units (“processors”) 602, main memory 606, non-volatile memory 610, network adapter 612 (e.g., network interfaces), video display 618, input/output devices 620, control device 622 (e.g., keyboard and pointing devices), drive unit 624 including a storage medium 626, and signal generation device 630 that are communicatively connected to a bus 616. The bus 616 is illustrated as an abstraction that represents any one or more separate physical buses, point-to-point connections, or both connected by appropriate bridges, adapters, or controllers. The bus 616, therefore, can include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire.”

In various embodiments, the computing system 600 operates as a standalone device, although the computing system 600 may be connected (e.g., wired or wirelessly) to other machines. In a networked deployment, the computing system 600 may operate in the capacity of a server or a client machine in a client-server network environment, or as a peer machine in a peer-to-peer (or distributed) network environment.

The computing system 600 may be a server computer, a client computer, a personal computer (PC), a user device, a tablet PC, a laptop computer, a personal digital assistant (PDA), a cellular telephone, an iPhone, an iPad, a Blackberry, a processor, a telephone, a web appliance, a network router, switch or bridge, a console, a hand-held console, a (hand-held) gaming device, a music player, any portable, mobile, hand-held device, or any machine capable of executing a set of instructions (sequential or otherwise) that specify actions to be taken by the computing system.

While the main memory 606, non-volatile memory 610, and storage medium 626 (also called a “machine-readable medium) are shown to be a single medium, the term “machine-readable medium” and “storage medium” should be taken to include a single medium or multiple media (e.g., a centralized or distributed database, and/or associated caches and servers) that store one or more sets of instructions 628. The term “machine-readable medium” and “storage medium” shall also be taken to include any medium that is capable of storing, encoding, or carrying a set of instructions for execution by the computing system and that cause the computing system to perform any one or more of the methodologies of the presently disclosed embodiments.

In general, the routines executed to implement the embodiments of the disclosure may be implemented as part of an operating system or a specific application, component, program, object, module or sequence of instructions referred to as “computer programs.” The computer programs typically comprise one or more instructions (e.g., instructions 604, 608, 628) set at various times in various memory and storage devices in a computer, and that, when read and executed by one or more processing units or processors 602, cause the computing system 600 to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices 610, floppy and other removable disks, hard disk drives, optical disks (e.g., Compact Disk Read-Only Memory (CD-ROMS), Digital Versatile Disks, (DVDs), Blu-Ray disks), and transmission type media such as digital and analog communication links.

The network adapter 612 enables the computing system 600 to mediate data in a network 614 with an entity that is external to the computing device 600, through any known and/or convenient communications protocol supported by the computing system 600 and the external entity. The network adapter 612 can include one or more of a network adaptor card, a wireless network interface card, a router, an access point, a wireless router, a switch, a multilayer switch, a protocol converter, a gateway, a bridge, bridge router, a hub, a digital media receiver, and/or a repeater.

The network adapter 612 can include a firewall, which can, in some embodiments, govern and/or manage permission to access/proxy data in a computer network, and track varying levels of trust between different machines and/or applications. The firewall can be any number of modules having any combination of hardware and/or software components able to enforce a predetermined set of access rights between a particular set of machines and applications, machines and machines, and/or applications and applications, for example, to regulate the flow of traffic and resource sharing between these varying entities. The firewall may additionally manage and/or have access to an access control list, which details permissions including for example, the access and operation rights of an object by an individual, a machine, and/or an application, and the circumstances under which the permission rights stand.

Other network security functions can be performed or included in the functions of the firewall, can include, but are not limited to, intrusion-prevention, intrusion detection, next-generation firewall, personal firewall, etc.

The techniques introduced herein can be embodied as special-purpose hardware (e.g., circuitry), or as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. The machine-readable medium may include, but is not limited to, floppy diskettes, optical disks, compact disk read-only memories (CD-ROMs), magneto-optical disks, read-only memories (ROMs), random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions.

### EXAMPLES

### Set 1

1. a method comprising:
randomly identifying portions of a predetermined human genome;
generating a limited-use cryptographic key from the randomly identified portions of the predetermined human genome; and
utilizing the limited-use cryptographic key as a public identity in a blockchain recorded action.

2. A method comprising:
receiving a sequenced genome; and
encoding the sequenced genome to a plurality of pixels wherein each of a plurality of bases in the sequenced genome corresponds to a single pixel of the plurality of pixels and each of the plurality of bases corresponds to the single pixel positioned according to an order of the sequenced genome.

### Set 2

1. A method of encoding genomic data to a machine-readable data structure comprising:
encoding a nitrogenous base of a genome and a metadata of the nitrogenous base to a single pixel, wherein a value of the single pixel corresponds to a predetermined combination of nitrogenous base and metadata of that nitrogenous base, and wherein an ordering position of the single pixel in the machine-readable data structure corresponds to an ordering position of the nitrogenous base in the genome; and
repeating said encoding for each nitrogenous base of the genome, thereby generating an encoded genome.

2. The method of example 1, further comprising:
applying image compression to the machine-readable data structure including the encoded genome.

3. The method of example 1, wherein the metadata of the nitrogenous base includes any combination of:
a quality of the read for the nitrogenous base;
whether the nitrogenous base was imputed;
whether the nitrogenous base is methylated, and the extent of methylation;
whether there has been copy number variations;
whether the nitrogenous base has particular relevance in DNA transcription, translation, or protein encoding;
whether the nitrogenous base is associated with a particular gene;
a technology platform used to determine the nitrogenous base;
a source of the nitrogenous base;
quantitative information on the structural scaffold of the genome; or
changes to the nitrogenous base over a period of time.

4. The method of example 1, wherein the metadata includes a time-varied nucleotide status, and the machine-readable data structure is a first machine-readable data structure, the method further comprising:
generating a second machine-readable data structure of the genome that includes metadata of the genome from a different time period than the first machine-readable data structure; and
assembling a video presentation including the first machine-readable data structure and the second machine-readable data structure as frames in the video presentation.

5. The method of example 4, wherein the genome differs over time as a result of metastasizing of a cancer.

6. The method of example 4, wherein the genome differs over time as a result of changes to a V(D)J adaptive immune system.

7. The method of example 1, further comprising:
generating a cryptographic key based on a plurality of pixels of the machine-readable data structure wherein pixels the cryptographic key is based have positions corresponding to single nucleotide polymorphisms (“SNPs”) of the genome.

8. The method of example 1, wherein the machine-readable data structure is a 2D or 3D image file.

9. The method of example 1, wherein the machine-readable data structure is a flat file.

10. A system comprising:
a machine-readable data structure stored in a memory configured to encode genomic data wherein each nitrogenous base of a genome and a metadata of that nitrogenous base are encoded to corresponding single pixels, wherein a value of each single pixel corresponds to a predetermined combination of nitrogenous base and metadata of that nitrogenous base, and wherein an ordering position of each single pixel in the machine-readable data structure corresponds to an ordering position of the nitrogenous base in the genome; and
a processor configured to read the machine-readable data structure.

11. The system of example 10, wherein the memory further includes instructions that when executed by the processor:
apply image compression to the machine-readable data structure including the encoded genome.

12. The system of example 10, wherein the metadata of the nitrogenous base includes any combination of:
a quality of the read for the nitrogenous base;
whether the nitrogenous base was imputed;
whether the nitrogenous base is methylated, and the extent of methylation;
whether there has been copy number variations;
whether the nitrogenous base has particular relevance in DNA transcription, translation, or protein encoding;
whether the nitrogenous base is associated with a particular gene;
a technology platform used to determine the nitrogenous base;
a source of the nitrogenous base;
quantitative information on the structural scaffold of the genome; or
changes to the nitrogenous base over a period of time.

13. The system of example 10, wherein the metadata includes a time-varied nucleotide status, and the machine-readable data structure is a first machine-readable data structure, wherein the memory further includes instructions that when executed by the processor:
generate a second machine-readable data structure of the genome that includes metadata of the genome from a different time period than the first machine-readable data structure; and
assemble a video presentation including the first machine-readable data structure and the second machine-readable data structure as frames in the video presentation.

14. The system of example 13, wherein the genome differs over time as a result of metastasizing of a cancer.

15. The system of example 10, wherein the memory further includes instructions that when executed by the processor:
generate a cryptographic key based on a plurality of pixels of the machine-readable data structure wherein pixels the cryptographic key is based have positions corresponding to single nucleotide polymorphisms (“SNPs”) of the genome.

16. The system of claim 10, wherein the machine-readable data structure is a 2D or 3D image file.

### Set 3

1. A method comprising:
in response to creation of a first new user account of a network, providing to a verification server, a first genome file or portion thereof;
automatically determining that the first genome file or portion thereof classifies as human; and
in response to said automatic determining, validating that the first new user account is associated with a real human.

2. The method of example 1, wherein said automatic determining further comprises:
aligning at the first genome file or portion thereof with a database of Homo sapien genomes; and
based on said aligning, identifying that the first genome or portion thereof mathematically relates to other genomes within the database of Homo sapien genomes as is consistent for a real human genome.

3. The method of example 2, wherein said validating is performed in response to said identifying.

4. The method of example 1, further comprising:
in response to creation of a second new user account of the network, providing to the verification server, a second genome file or portion thereof;
automatically aligning at the second genome file or portion thereof with the database of Homo sapien genomes;
based on said aligning, identifying the second genome file or portion thereof does not mathematically relate to other genomes within the database of Homo sapien genomes as is consistent for a real human genome; and
in response to said identifying, determining that the second new user account is not associated with a real human.

5. The method of example 1, wherein the first genome file is a machine-readable data structure encoding genomic data wherein each nitrogenous base of a genome and a metadata of that nitrogenous base are encoded to corresponding single pixels, wherein a value of each single pixel corresponds to a predetermined combination of nitrogenous base and metadata of that nitrogenous base, and wherein an ordering position of each single pixel in the machine-readable data structure corresponds to an ordering position of the nitrogenous base in the genome.

6. The method of example 1, further comprising:
identifying that an existing user account is linked to the first genome file or portion thereof; and
linking the existing user account and the first new user account together as belonging to a same human.

7. The method of example 1, wherein the first new user account is generated on a social networking platform.

8. The method of example 1, further comprising:
issuing a remedial action on each user account not associated with a real human.

9. A system comprising:
a verification server configured to receive a first genome file or portion thereof in response to creation of a first new user account of a network;
a processor; and
a memory including instructions that when executed cause the processor to:
   automatically determine that the first genome file or portion thereof classifies as human; and
   in response to said automatic determination, validate that the first new user account is associated with a real human.

10. The system of example 9, wherein said automatic determination further comprises:
aligning at the first genome file or portion thereof with a database of Homo sapien genomes; and
based on said aligning, identifying that the first genome or portion thereof mathematically relates to other genomes within the database of Homo sapien genomes as is consistent for a real human genome.

11. The system of example 10, wherein said validation is performed in response to said identifying the taxon within the database of Homo sapien genomes.

12. The system of example 9, wherein the instructions further comprise:
in response to creation of a second new user account, providing to the verification server, a second genome file or portion thereof;
automatically aligning at the second genome file or portion thereof with the database of Homo sapien genomes;
based on said aligning, identifying the second genome file or portion thereof does not mathematically relate to other genomes within the database of Homo sapien genomes as is consistent for a real human genome; and
in response to said identifying, determining that the second new user account is not associated with a real human.

13. The system of example 9, wherein the first genome file is a machine-readable data structure encoding genomic data wherein each nitrogenous base of a genome and a metadata of that nitrogenous base are encoded to corresponding single pixels, wherein a value of each single pixel corresponds to a predetermined combination of nitrogenous base and metadata of that nitrogenous base, and wherein an ordering position of each single pixel in the machine-readable data structure corresponds to an ordering position of the nitrogenous base in the genome.

14. The system of example 9, wherein the instructions further comprise:
identifying that an existing user account is linked to the first genome file or portion thereof; and
linking the existing user account and the first new user account together as belonging to a same human.

15. The system of example 9, wherein the first new user account is generated on a social networking platform.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

I claim:

1. A method comprising:
receiving a genomic information of a user, the genomic information including a set of single nucleotide polymorphisms (“SNPs”);
generating a cryptographic key associated with the user based on the set of SNPs; and
validating the user from the cryptographic key via zero-knowledge proof, wherein the user is enabled to satisfy the proof with the genomic information.

2. The method of claim 1, further comprising:
prior to generating the cryptographic key based on the set of SNPs, modifying the set of SNPs into a binary sequence based on whether each given allele of the set of SNPs matches a reference genome for a respective genome position.

3. The method of claim 1, wherein the cryptographic key is a one-time-key, and the generation of the cryptographic key further comprises:
determining a random subset of the set of SNPs from which to base the cryptographic key.

4. The method of claim 3, further comprising:
storing positions of the random subset of the set of SNPs, wherein the positions in combination with the genomic information are employed by the user to complete the zero-knowledge proof.

5. The method of claim 3, wherein the cryptographic key is a public key of an asymmetric keypair, the method further comprising:
initiating a blockchain-recorded interaction wherein the user is identified via the one-time-key.

6. The method of claim 1, wherein the genomic information further includes epigenetic modification or other time-varied statuses and wherein the cryptographic key is further based on the epigenetic modification or other time-varied statuses.

7. The method of claim 6, wherein the epigenetic modifications or other time-varied statuses include any of:
DNA methylation;
histone acetylation;
non-coding RNA associated gene silencing;
time point based transcriptome information; or
V(D)J adaptive immune system status.

8. The method of claim 3, further comprising:
transmitting data, by the user, to an entity wherein the user is identified in the transmission by the one-time-key based on the random subset of the set of SNPs.

9. A system comprising:
a processor;
a memory including genomic information of a user, the genomic information including a set of single nucleotide polymorphisms (“SNPs”), the memory further having instructions that when executed cause the processor to:
generate a cryptographic key associated with the user based on the set of SNPs; and
validate the user from the cryptographic key via zero-knowledge proof, wherein the user is enabled to satisfy the proof with the genomic information.

10. The system of claim 9, the memory further including instructions that when executed cause the processor to:
prior to generating the cryptographic key based on the set of SNPs, modify the set of SNPs into a binary sequence based on whether each given allele of the set of SNPs matches a reference genome for a respective genome position.

11. The system of claim 9, wherein the cryptographic key is a one-time-key, and the generation of the cryptographic key further comprises:
determining a random subset of the set of SNPs from which to base the cryptographic key.

12. The system of claim 11, the memory further including instructions that when executed cause the processor to:
store positions of the random subset of the set of SNPs, wherein the positions in combination with the genomic information are employed by the user to complete the zero-knowledge proof.

13. The system of claim 11, wherein the cryptographic key is a public key of an asymmetric keypair, the memory further including instructions that when executed cause the processor to:
initiate a blockchain-recorded interaction wherein the user is identified via the one-time-key.

14. The system of claim 9, wherein the genomic information further includes epigenetic modification or other time-varied statuses and wherein the cryptographic key is further based on the epigenetic modification or other time-varied statuses.

15. The system of claim 14, wherein the epigenetic modifications or other time-varied statuses include any of:
DNA methylation;
histone acetylation;
non-coding RNA associated gene silencing;
time point based transcriptome information; or
V(D)J adaptive immune system status.

16. The system of claim 11, further comprising:
a network interface configured to transmit data, by the user, to an entity wherein the user is identified in the transmission by the one-time-key based on the random subset of the set of SNPs.

17. A method comprising:
receiving a genome of a user, the genomic information including a set of single nucleotide polymorphisms (“SNPs”);
generating a one-time-cryptographic key (“genomic key”) associated with the user based on a random subset of the set of SNPs as a seed sequence, wherein the genomic key is a public key of an asymmetric key pair that identifies the user in a blockchain-recorded interaction;
storing positions of the random subset of the set of SNPs;
initiating the blockchain-recorded interaction between the user and an entity identified by a respective public key, wherein the user is identified on the blockchain via the genomic key for that blockchain-recorded interaction only; and
subsequent to appending the blockchain-recorded interaction to the blockchain, validating that the user participated in the blockchain-recorded interaction from the genomic key via zero-knowledge proof, wherein the user is enabled to satisfy the proof with the stored positions in combination with the genomic information.

18. The method of claim 17, wherein the blockchain-recorded interaction is a submission of personally identifying information (PII) associated with the user, the method further comprising:
requesting access, by the user from the entity, of the PII, thereby triggering said validating by the entity.

19. The method of claim 17, further comprising:
prior to generating the genomic key based on the sequence of SNPs, modifying the sequence of SNPs into a binary sequence based on whether each given allele of the sequence of SNPs matches a reference genome for a respective genome position.

20. The method of claim 17, wherein the genomic information further includes DNA methylation status, and the genomic key is further based on the DNA methylation status.

21. The method of claim 17, wherein the genomic key is generated via a one-way hash function applied to genomic elements from which the genomic key is based.

22. The method of claim 17, wherein the genomic key is further based on any of:
RNA expression signatures at specific time points;
genomic structural variants;
copy number variations (CNV); or
correlated regions of systemic interindividual variation (CORSIVs).
